(19) United States
(12) Patent Application Publication
(10) Pub. No.: US 2009/0044329 A1
(43) Pub. Date: Feb. 19, 2009

(54) SELF-SUPPORTING SHOWER HEAD SYSTEM

(76) Inventors: Matthew Kestian, Irvine, CA (US); Rebecca Kestian, Irvine, CA (US)

Correspondence Address: CHRISTIE, PARKER & HALE, LLP, PO BOX 7068, PASADENA, CA, 91109-7068, US

(21) Appl. No.: 12/171,088

(22) Filed: Jul. 10, 2008

Related U.S. Application Data
(60) Provisional application No. 60/955,846, filed on Aug. 14, 2007.
(60) Provisional application No. 61/031,335, filed on Feb. 25, 2008.

(51) Int. Cl. A47K 3/28; B23P 15/00

(52) U.S. Cl. 4/601; 4/612; 29/428

(57) ABSTRACT

A self-supporting shower head system including a hollow center section configured to couple with a flexible tube, at least one shower head coupled to the center section, and at least one telescoping rod coupled to the center section, where the at least one telescoping rod is configured to extend away from and to retract toward the center section, wherein the flexible tube is configured to couple with at least one shower outlet pipe and to provide water to the at least one shower head.

### CROSS-REFERENCE TO RELATED APPLICATION(S)

This application claims priority to and the benefit of U.S. Provisional Application Nos. 60/955,846 and 61/031,335, filed on Aug. 14, 2007 and Feb. 25, 2008, respectively, which are incorporated by reference as if set forth in full herein.

### BACKGROUND

The present invention relates generally to shower heads, and more particularly to support systems for shower heads.

Shower heads are typically mounted at an angle less than ninety degrees to one side wall of a shower stall to direct water onto a bather in the shower stall. The height of the shower head often does not suit the height of a bather. A short bather may adjust the shower head lower than the default position to direct the flow of water on the short bather's head and shoulders. On the other hand, a tall bather may be unable to adjust the shower head to direct the flow of water on the tall bather's head. Often, conventional shower heads are simply inadequate to accommodate a tall bather.

Conventional shower heads spray water on just a portion of a bathtub or a shower closet floor and thus do not direct water to the larger area available on the bathtub or shower closet floor. The angled shower head requires substantial pressure to enable a suitable flow of water at various angles. Typical shower heads have limited customizable features and substantially restrict the volume of water that a bather can enjoy, often due to the use of a single stationary shower head.

Shower heads mounted on the end of flexible tubes have similar limitations. The flexible tube shower heads fail to provide consistent water flow to a tall bather's head and shoulders. While a tall bather may hold the flexible tube shower head above the bather's head for some period of time, the tall bather will quickly become weary of holding the device above the bather's head. A flexible tube shower head similarly sprays water on just a portion of the shower closet floor area or bathtub and typically uses the limited volume of water associated with a single shower head.

Overhead shower systems can be useful in this regard but are difficult to install. Installation of such systems requires a variety of tools, numerous components to assemble, and often the service of a plumber. Thus, the installation requires a significant amount of time to complete and can be rather expensive.

### SUMMARY OF THE INVENTION

Aspects of the present invention relate to a self-supporting shower head system. In one embodiment the invention relates to a self-supporting shower head system including a hollow center section configured to couple with a flexible tube, at least one shower head coupled to the center section, and at least one telescoping rod coupled to the center section, where the at least one telescoping rod is configured to extend away from and to retract toward the center section, wherein the flexible tube is configured to couple with at least one shower outlet pipe and to provide water to the at least one shower head.

In another embodiment, the invention relates to a method of installing a self-supporting shower head system in a shower stall, the self-supporting shower head system having a hollow center section configured to couple with a flexible tube, at least one shower head coupled to the center section, and at least one telescoping rod coupled to the center section, where the at least one telescoping rod is configured to extend away from and to retract toward the center section, where the flexible tube is configured to couple with at least one shower outlet pipe and to provide water to the at least one shower head, the method including extending the at least one telescoping rod to a wall of the shower stall, and coupling the flexible tube to the at least one shower outlet pipe and to the center section.

In yet another embodiment, the invention relates to a self-supporting shower head system including a hollow center section configured to couple with a flexible tube, at least one shower head coupled to the center section, at least one telescoping rod coupled to the center section, and means for extending and retracting the at least one telescoping rod, wherein the flexible tube is configured to couple with at least one shower outlet pipe and to channel water to the at least one shower head.

### BRIEF DESCRIPTION OF THE DRAWINGS

FIG. 1 is an elevational view of a shower stall having a self-supporting shower head system in accordance with an embodiment of the invention;

FIG. 2 is a side elevational view, partially broken away, of a self-supporting shower head system having telescoping rods in an extended position in accordance with an embodiment of the invention;

FIG. 3 is a side elevational view, partially broken away, of the self-supporting shower head system of FIG. 2 having telescoping rods in a retracted position;

FIG. 4 is a exploded side view of a portion of the self-supporting shower head system of FIG. 2 and FIG. 3;

FIG. 4a is an enlarged end view of a threaded end in accordance with the embodiments of FIG. 4;

FIG. 5 is a front view of a wall mount in accordance with an embodiment of the invention;

FIG. 6 is a side view of the wall mount of FIG. 5;

FIG. 7 is a partial vertical sectional view of a self-supporting shower head system having telescoping rods in an extended position in accordance with another embodiment of the invention;

FIG. 8 is a partial vertical sectional view of a self-supporting shower head system having telescoping rods and springs in accordance with another embodiment of the invention;

FIG. 9 is a partial vertical sectional view of a self-supporting shower head system having telescoping rods and springs in accordance with another embodiment of the invention;

FIG. 10 is a lower perspective view of a self-supporting shower head system having a multi-inlet shower head in accordance with an embodiment of the invention;

FIG. 11 is a perspective view of a shower stall and a self-supporting shower head system in accordance with an embodiment of the invention;

FIG. 12 is a side view of the self-supporting shower head system of FIG. 11;

FIG. 13 is a sectional view taken along the section 13-13 of the self-supporting shower head system of FIG. 12;

FIG. 14 is a top view of the self-supporting shower head system of FIG. 11;

FIG. 15 is a sectional view taken along the section 15-15 of the self-supporting shower head system of FIG. 14;

FIG. 16 is a perspective view of a portion of the self-supporting shower head system of FIG. 11;

FIG. 17 is a perspective view of a self-supporting shower head system in accordance with an embodiment of the invention;

FIG. 18 is a side view of the self-supporting shower head system of FIG. 17;

FIG. 19 is a top view of the self-supporting shower head system of FIG. 17; and

FIG. 20 is a sectional view taken along the section 20-20 of the self-supporting shower head system of FIG. 19.

### DETAILED DESCRIPTION

Referring now to the drawings, embodiments of self-supporting shower head systems have telescoping support rods that support a number of shower heads are illustrated. The telescoping support rods extend outward and retract inward using a variety of configurations. In one embodiment, self-supporting shower head systems include a hollow center section coupled to two telescoping support rods. The telescoping support rods can be extended and retracted using a length of threaded rod contained within the telescoping support rods. In another embodiment, the telescoping support rods are extended and retracted using a spring. In some embodiments, the telescoping support rods are extended and retracted using a pawl and fixed teeth. In various embodiments, the telescoping rods include braking mechanisms that help support the weight of the self-supporting shower head systems and facilitate easy installation.

In some embodiments, self-supporting shower head systems support three or more shower heads. In such case, a greater volume of water is available to the bather than is available to a bather using a conventional shower head assembly. Each shower head can be adjusted individually to direct water downward or at an angle. In many embodiments, each shower head assembly has a valve enabling individual adjustment of the volume of water flow.

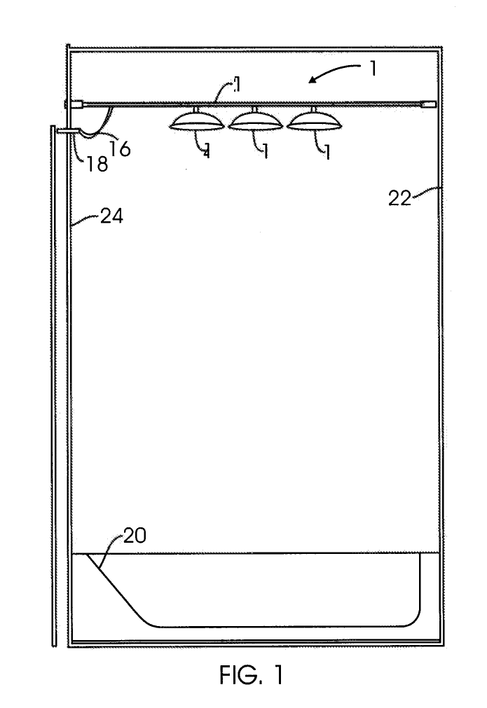

FIG. 1 is an elevational view of a shower stall having a self-supporting shower head system in accordance with an embodiment of the invention. The self-supporting shower head system 10 includes a telescoping support structure 12, three shower heads 14 and a flexible tube 16. The telescoping support structure 12 includes a center section and two telescoping rods that extend from and retract to the center section. In the illustrated embodiment, one telescoping rod is extended to the back wall 22. The other telescoping rod is extended to a front wall 24. Outward force from both telescoping rods retains the self-supporting shower head systems in the illustrated position. The three shower heads 14 are suspended from the telescoping support structure and direct water onto a bather (not shown) within the bath tub 20. The three shower heads receive water provided by the flexible tube 16. The flexible tube 16 is coupled to a shower head outlet 18 and to the telescoping support structure 12. The flexible tube 16 receives water from the shower head outlet 18. In one embodiment, more than one flexible tube is used to couple to more than one shower head outlet.

To install the self-supporting shower head system, the installer extends the telescoping rods such that the length of the self-supporting shower head system is just less than the distance between the front wall and the back wall. The installer positions the self-supporting shower head system in the desired position and extends one or both telescoping rods until both rods are in contact with the walls or wall mounts fixed to the walls. The installer removes the conventional shower head and couples the flexible tubing to the shower outlet pipe. In operation, a bather opens existing valves (not shown) to cause water to flow from the shower outlet pipe into the flexible tube and the shower heads. In other embodiments, other methods of installing the self-supporting shower head system can be used.

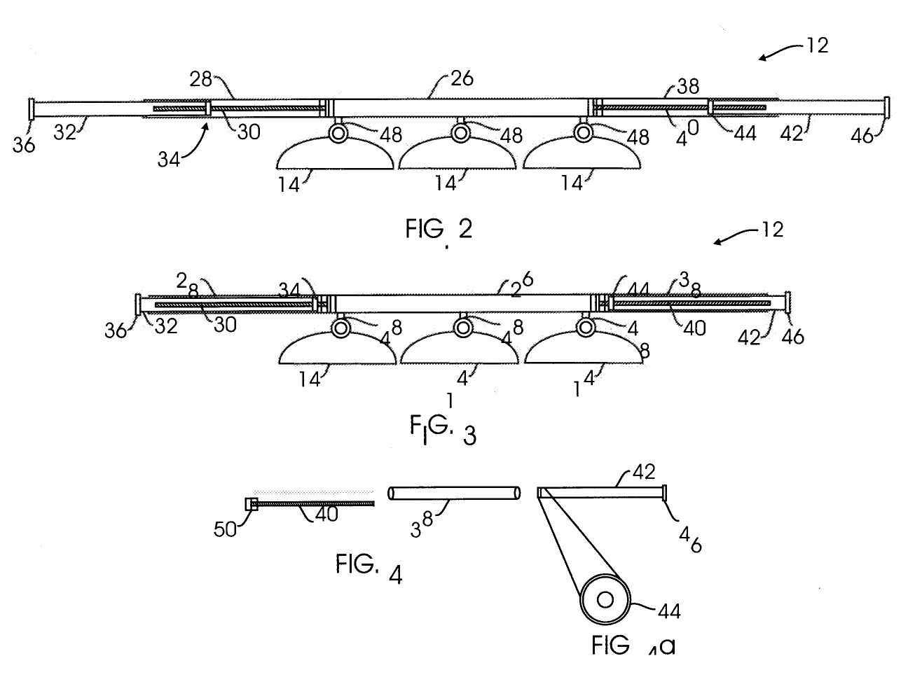

FIG. 2 is a side elevational view, partially broken away, of a self-supporting shower head system having telescoping rods in an extended position in accordance with an embodiment of the invention. The system 12 includes a center pipe section 26 fixed to a left pipe end section 28, a right pipe end section 38 and three shower head mounts 48. The left pipe end section 28 encloses a length of threaded rod 30 fixed substantially within the center of the left pipe end section. A threaded end 34 fixed to one end of a left telescoping rod 32 rotably engages the threaded rod 30 similar to the way a nut rotably engages a bolt. In another embodiment, the threaded end 34 of the left telescoping rod 32 may include a nut or threaded block (not shown) which engages the threaded rod 30. A wall mounting end 36 of the left telescoping rod 34 is disposed opposite the threaded end 34. The left pipe end section 28 is fixed to the center pipe section. In the illustrated embodiment, the left pipe end section 28 and the left telescoping rod 32 are cylindrical and hollow. The diameter of the left telescoping rod 32 is slightly smaller in diameter than the left pipe end section 28 such that the left telescoping rod fits snuggly within the left pipe section. The left pipe telescoping rod can be rotated like a nut onto the threaded rod 30 which is disposed substantially in the center of the left pipe end section 28.

The right pipe end section 38 encloses a length of threaded rod 40 fixed substantially within the center of the right pipe end section. A threaded end 44 fixed to one end of a right telescoping rod 42 rotably engages the threaded rod 40 similar to the way a nut rotably engages a bolt. In another embodiment, the threaded end 44 of the right telescoping rod 42 may include a nut or threaded block (not shown) which engages the threaded rod 40. A wall mounting end 46 of the right telescoping rod 42 is disposed opposite the threaded end 44. The right pipe end section 38 is fixed to the center pipe section. In the illustrated embodiment, the right pipe end section 38 and the right telescoping rod 42 are cylindrical and hollow. The diameter of the right telescoping rod 42 is slightly smaller in diameter than the right pipe end section 38 such that the right telescoping rod fits snuggly within the right pipe section. The right pipe telescoping rod can be rotated like a nut onto the threaded rod 40 which is disposed substantially in the center of the right pipe end section 38.

Each of the three shower head mounts 48 couples the center pipe section 26 to one of the three shower heads 14. Each shower head mount 48 includes an adjustable valve for controlling the volume of water flowing to the shower head attached to the particular mount. Each shower head mount 48 is configured to enable adjustment of the angle of the shower head attached thereto.

In operation, the telescoping rods can be rotated such that they are either extended or retracted based on the direction of rotation applied to the rods. In many embodiments, the telescoping rods are extended to the wall until they apply an outward force to the wall sufficient to avoid any slipping between the wall mounting ends and the wall. In other embodiments, wall mounts (see FIG. 5) are mounted on the walls for receiving the wall mounting ends 36, 46.

The upper portion of the center pipe section 26 includes an inlet (not shown) for coupling to a flexible tube (see FIG. 1). In one embodiment, the inlet is a threaded male protrusion that can be coupled with a female end of the flexible tube. In such case, the center pipe section 26 is filled with water and provides the water to each of the shower heads 14 via the shower head mounts 48. The shower head mounts 48 can be coupled to threaded male protrusions on the lower portion of the center pipe section 26. In other embodiments, other methods of connecting pipes known in the art can be used to couple the flexible tube to the center pipe section or to couple the shower head mounts to the center pipe section.

In another embodiment, the inlet is an opening configured to receive the flexible tube. In such case, the flexible tube extends into the interior of the center pipe section 26 and is routed to each of the shower head mounts 48. In one embodiment, the inlet flexible tube is coupled to a set of three flexible tubes via a three way coupler. In other embodiments, other methods of distributing the water from the inlet flexible tube to the shower head mounts known in the art can be used.

FIG. 3 is a side elevational view, partially broken away, of the self-supporting shower head system of FIG. 2 having telescoping rods in a retracted position.

FIG. 4 is a exploded side view of a portion of the self-supporting shower head system of FIG. 2 and FIG. 3. The illustrated portion of the self-supporting shower head system includes a telescoping rod 42, a fixed pipe end section 38 and a threaded rod 40. The threaded rod includes a cylindrical head 50 disposed at one end of the rod. The head can be attached to the fixed pipe end section 38 by a weld, an adhesive or other suitable method of attachment known in the art.

FIG. 4a is an enlarged end view of a threaded end 44 in accordance with the embodiments of FIG. 4. The threaded end 44 includes a threaded cylindrical opening configured to receive the threaded rod 40 (see FIG. 4). In one embodiment, the threaded end 44 is welded to the telescoping rod 42. In another embodiment, the threaded end is shaped like a threaded cylindrical cap and threads onto an outer portion of the telescoping rod. In other embodiments, other methods of attaching the threaded end to the telescoping rod can used.

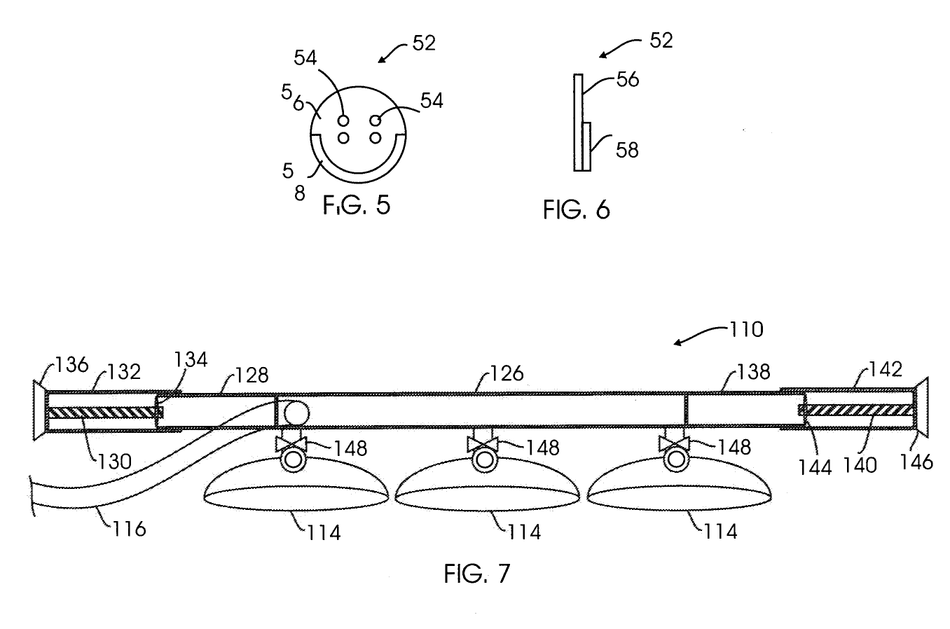

FIG. 5 is a front view of a wall mount in accordance with an embodiment of the present invention. The wall mount 52 includes four mounting holes 54, a front surface 56 and a curved vertical retainer 58. The four mounting holes 54 are configured to receive mounting screws. In other embodiments, other fasteners can be used to mount the wall mount to a wall. In the illustrated embodiment, the front surface 56 is circular in shape and includes the vertical retainer 58. In other embodiments, the front surface can take other shapes. In the illustrated embodiment, the front surface and vertical retainer are one unit. In other embodiments, the vertical retainer is affixed to the front surface. The vertical retainer 58 is semicircular in shape and is raised in a direction perpendicular to the front surface 56. In one embodiment, the wall mount may be made of porcelain, metal, rubber, polyvinyl chloride (PVC), or any other suitable material or combination of materials. FIG. 6 is a side view of the wall mount of FIG. 5.

FIG. 7 is a partial vertical sectional view of a self-supporting shower head system 110 having telescoping rods 132, 142 in an extended position in accordance with another embodiment of the invention. The self-supporting shower head system 110 includes a center section 126 fixed to fixed pipe sections 128, 138 having threaded ends 134, 144 disposed opposite of the center section. Threaded rods 130, 140 are affixed to and disposed substantially in the center of the telescoping rods 132, 142. The telescoping rods have a diameter slightly greater than the fixed pipe sections. Wall mounting ends 136, 146 are disposed at the outermost ends of the telescoping rods 132, 142. Three shower heads 114 are coupled to the center section 126 via shower head mounts 148. The center section 126 is coupled to a flexible tube 116 which supplies water to the shower heads. The telescoping rods and shower head mounts can operate as described previously.

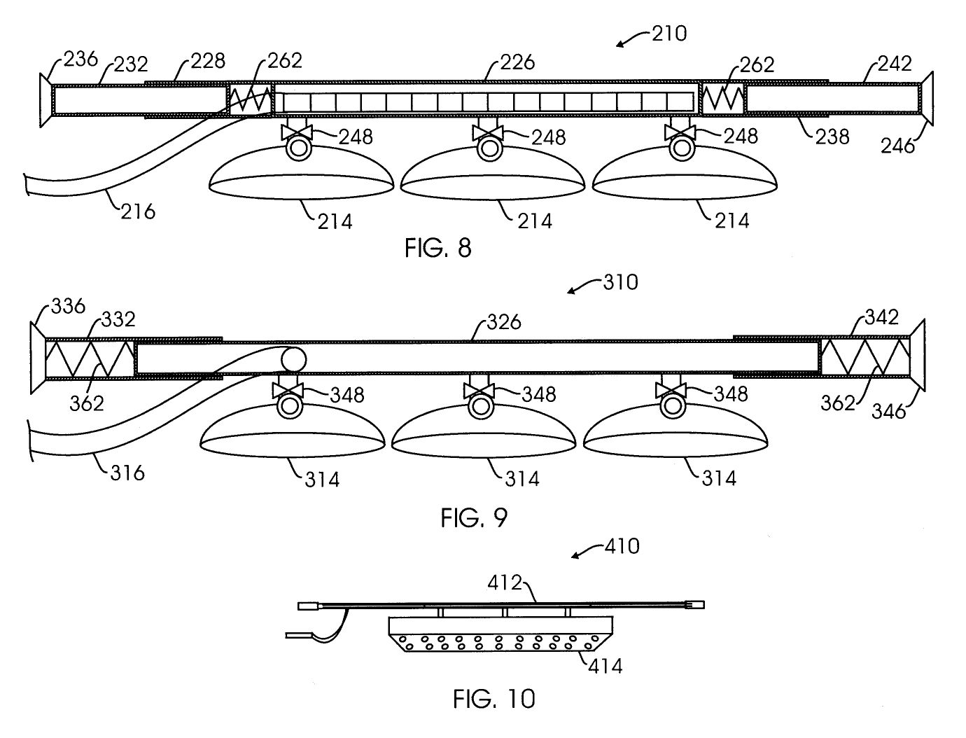

FIG. 8 is a partial vertical view of a self-supporting shower head system 210 having telescoping rods 232, 242 and springs 262 in accordance with another embodiment of the invention. The self-supporting shower head system 210 includes a center section 226 fixed to fixed pipe sections 228, 238 having open ends disposed opposite of the center section. Telescoping rods 232, 242 are cylindrical pipes with closed ends. The outer end of each telescoping rod is attached to a wall mounting end (236 or 246). The inner end of each telescoping rod abuts a spring 262 that is disposed between the telescoping rod end and the non-open end of each fixed pipe section 228, 238.

Three shower heads 214 are coupled to the center section 226 via shower head mounts 248. The center section 226 is coupled to a flexible tube 216 which supplies water to the shower heads.

In the illustrated embodiment, the center section 226 receives the flexible tube 216 which extends inside the center section to provide water to each of the shower heads 214.

In operation, the springs provide an outward force via the telescoping rods to the wall or wall mount sufficient to avoid any slipping between the wall mounting ends and the wall. To install the spring loaded self-supporting shower head system, an installer compresses one or both ends and positions the system in the desired location. The installer allows the ends to extend such that the springs provide force via the telescoping rods to the wall or wall mounts. The telescoping rods and shower head mounts can otherwise be operated as described previously.

FIG. 9 is a partial vertical sectional view of a self-supporting shower head system 310 having a center section 326, telescoping rods 332, 342 and springs 362 in accordance with another embodiment of the invention. The center section 326 extends further in this embodiment than in other illustrated embodiments. As a result, the fixed pipe sections are not needed in this embodiment. The telescoping rods 332, 342 each have a cylindrical pipe shape with an open inner end and a closed outer end. The diameter of the telescoping rods 332, 342 is just larger than the center section pipe 326 such that they fit tightly over the center pipe section. The closed end of each telescoping rod is affixed to a wall mounting end 336, 346. The open end of each telescoping rod abuts a spring 362 which also abuts an end of the center pipe section 326. In operation, the telescoping rods can function as described above for the embodiment of FIG. 8.

FIG. 10 is a lower perspective view of a self-supporting shower head system 410 having a multi-inlet shower head 414 in accordance with an embodiment of the invention. The system 410 includes a telescoping support structure 412 and the multi-inlet shower head 414. The multi-inlet shower head 414 can be attached to any of the previously discussed telescoping support structures. The multi-inlet shower head 414 has a rectangular box like shape with a large number of water outlets. The multi-inlet shower head 414 can provide an adjustable volume of water across a wide area.

In one embodiment, the self-supporting shower head systems can be made of materials such as metal or PVC. In one embodiment, the metal can be copper, aluminum, steel or a combination of any of those metals. In other embodiments, other metals or metal composites can be used. In other embodiments, other materials common for a variety of plumbing applications can be used.

In one embodiment, additional right and left pipe sections can be coupled to the center section to accommodate wide variations in length of the shower stall. In another embodiment, solid right and left pipe sections with threaded holes can couple with threaded rod extending from left and right telescoping rods. In such case, the ends of the right and left pipe sections have threaded openings and are configured to rotably engage with telescoping rods having threaded rods that are configured to mate with the right and left pipe sections. In another embodiment, a combination of any number of threaded pipe sections, threaded rods and springs is used to provide the telescoping functionality for the self-supporting shower head systems.

In one embodiment, the self-supporting shower head system is supported using a single telescoping rod. In such case, the non-telescoping end of the self-supporting shower head system can rest against a wall or within a wall mount fixed on the wall while the telescoping end can be extended to the opposite wall. In all other aspects, the single telescoping rod embodiment can perform in the same manner as described above in relation to the other embodiments of the self-supporting shower head system.

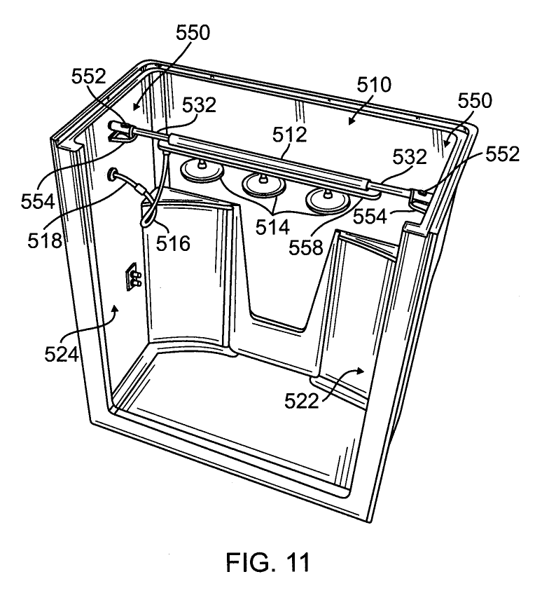

FIG. 11 is a perspective view of a shower stall and a self-supporting shower head system in accordance with an embodiment of the invention. The system 510 is coupled by a flexible tube 516 to a shower head outlet 518. The system 510 includes a center pipe section 512, a water chamber 558, two telescoping rods 532 and three shower heads 514. The water chamber 558 is affixed to and disposed below the center pipe section 512. The three shower heads 514 are coupled to the water chamber 558. The flexible tube 516 is coupled to both the water chamber 558 and the shower head outlet 518. The center pipe section 512 is configured to receive the two telescoping rods 532. Each telescoping rod includes a release button 552 and a self-energizing brake 554 coupled to the telescoping end of the rod. Each telescoping rod can further include a contact pad at the end of the rod for engaging and adhering to a shower wall.

In operation, the flexible tube 516 receives water from the shower outlet 518 and directs the water into the water chamber 558. Water in the water chamber 558 is directed through the three shower heads 514 and provided for a bather. The telescoping rods 532 extend from the center pipe section 512 to the shower walls (522, 524). Outward force from the telescoping rods 532 and self-energizing brakes 554 coupled thereto supports the weight of the self-supporting shower head system and water contained therein. In one embodiment, the self-supporting shower head system 510 can be installed as described for the embodiment of FIG. 1.

In a number of embodiments, the water chamber 558 is affixed to the center pipe section 512 using a welding process. In other embodiments, other methods of securing the water chamber to the center pipe section can be used. In some embodiments, the water chamber 558 and center pipe section 512 compose a single unit and do not need to be affixed to one another. In one such embodiment, the single unit is fabricated using an injection molding process. In another embodiment, the unit is implemented using plastic casting. In other embodiments, the unit is implemented using other suitable methods known in the art.

The self-energizing brakes (552, 554) provide a robust support structure for the self-supporting shower head system. When installed, the self-energizing brakes can be configured to remain stationary such that they are angled downward from the telescoping rods and contact the side walls. The orientation of the self-energizing brake can provide a level of structural support greater than found in embodiments not including such a feature.

In the illustrated embodiment, the self-energizing brakes have an horseshoe shaped structure that is enclosed by a crossbar where the enclosing crossbar includes a rubber contact pad for engaging and adhering to a shower wall. The rounded portion of the horseshoe shaped structure is coupled to a rounded clamp-like structure that is configured to snuggly circumscribe one of the telescoping rods. In other embodiments, the self-energizing brakes can take other shapes suitable for providing support to the self-supporting shower head systems.

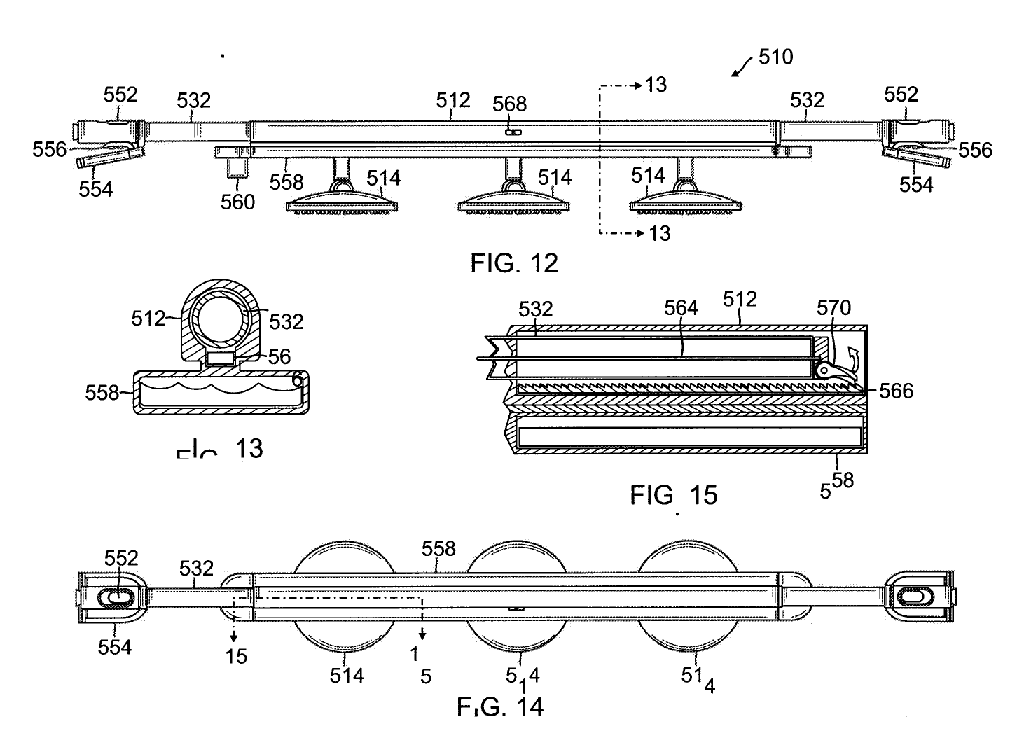

FIG. 12 is a side view of the self-supporting shower head system 510 of FIG. 11. The system further includes a cam lock 556 for the self-energizing brake 554, an inlet 560 for the water chamber 558 and a level indicator 568 that can be used to ensure a suitable orientation of the shower head system during installation. The cam lock 556 can act to support the self-energizing brake 554 when the weight of the shower system provides a downward force in a typical installed configuration. The downward force can result in a rotation force on the brake about a pivot point. The cam lock 556 can resist the rotation force and lock the position of the self-energizing brake 554 with respect to the telescoping rod 532 coupled thereto.

FIG. 13 is a sectional view taken along the section 13-13 of the self-supporting shower head system of FIG. 12. The sectional view illustrates the orientation of the telescoping rod 532 within the center pipe section 512. A bottom portion of the center pipe section 512 is coupled to the water chamber 558. The bottom of the center pipe section 512 includes a length-wise groove. A ratchet tooth bar 566 is disposed within the groove such that the ratchet teeth are directed upward toward the telescoping rod 532 (see also FIG. 15).

FIG. 14 is a top view of the self-supporting shower head system of FIG. 11.

FIG. 15 is a sectional view taken along the section 15-15 of the self-supporting shower head system of FIG. 14. The telescoping rod 532 includes a wire release mechanism 564 coupled to a pawl 570 rotably coupled to the non-extruding end of the telescoping rod 532 within the center pipe section 512. The pawl 570 is configured to engage the ratchet teeth of the ratchet tooth bar 566. In a number of embodiments, the pawl is spring loaded such that the default position of the pawl includes the engagement of the ratchet teeth on the ratchet tooth bar 566. The wire release mechanism is further coupled to the release button 552. In operation, a user of the self-supporting shower head system can press the release button 552 to disengage the pawl from the ratchet teeth. The release button provides a force to the wire release mechanism which can be translated along the wire release mechanism to counteract the spring force and disengage the pawl from the ratchet teeth. In other embodiments, other mechanisms can be used to lock and release the telescoping rods.

A corresponding telescoping rod and release system matching the embodiment illustrated in FIG. 15 is also configured at the other end of the center pipe section.

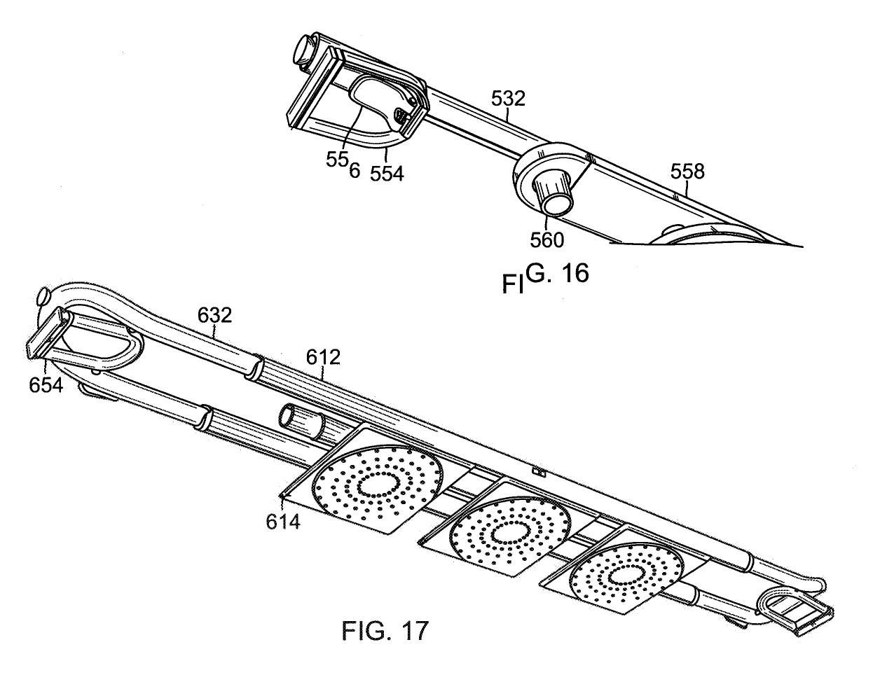

FIG. 16 is a perspective view of a portion of the self-supporting shower head system of FIG. 11.

In some embodiments, the self-supporting shower head system can operate without the self-energizing brake. In one embodiment, the self-energizing brake can operate without the cam lock. In one embodiment, the self-energizing brake can take any number of suitable shapes.

FIG. 17 is a perspective view of a self-supporting shower head system in accordance with an embodiment of the invention. The self-supporting shower head system includes a center pipe support structure 612, telescoping rod structures 632, self-energizing brakes 654 and shower heads 614. The center pipe support structure 612 includes a center water chamber 658 (see FIG. 19) coupled by two short cross-rods to two support pipes. The two support pipes are configured to receive two telescoping rods of the telescoping rod structures 632 at both ends of each support pipes. The self-energizing brakes 654 are coupled to the telescoping rod structures 632 and are configured to brace and lock the self-supporting shower head system once the telescoping rod structures have been extended to the walls of the shower stall.

In the illustrated embodiment, the self-energizing brakes have an horseshoe shaped pipe structure that is enclosed by a crossbar where the enclosing crossbar includes a rubber contact pad for engaging and adhering to a shower wall. The horseshoe shaped pipe structure is coupled by pins to each of two rods of the telescoping rod structure. The pins can enable rotation of the self-energizing brake about an axis that is both level and perpendicular to the rods of the telescoping rod structure. Cam locks can be mounted to the pins and can enable the brakes to be locked into a particular position with respect to the telescoping rods. In other embodiments, the self-energizing brakes can take other shapes suitable for providing support to the self-supporting shower head systems. For example, in one embodiment, the brake can be implemented using a horseshoe shape, a rectangular shape or a square shape. In another embodiment, the brake is implemented using a pipe section that is coupled a telescoping rod structure by a hinge mechanism. In other embodiments, other shapes are used.

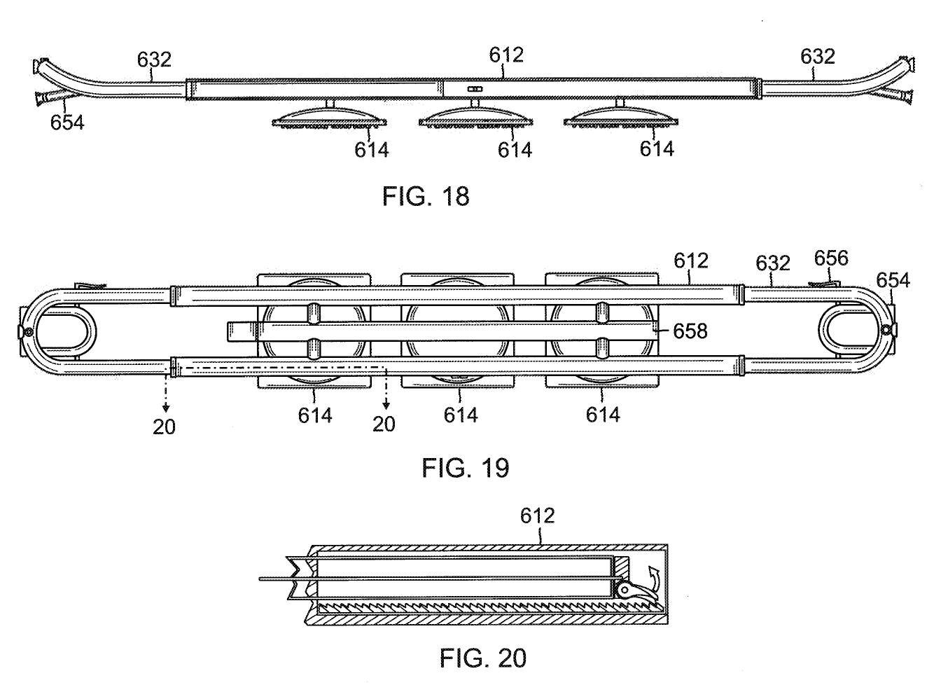

FIG. 18 is a side view of the self-supporting shower head system of FIG. 17.

FIG. 19 is a top view of the self-supporting shower head system of FIG. 17. Cam locks 656 coupled to the telescoping rod structures can secure the position of a self-energizing brakes with respect to the telescoping rod structures.

FIG. 20 is a sectional view taken along the section 20-20 of the self-supporting shower head system of FIG. 19. A ratchet tooth and pawl system with a button release on the telescoping rod structures enables the structures to be extended and locked into the extended position. The button allows the release of the telescoping rod structure from the locked position. In one embodiment, the self-supporting shower head system operates in a similar fashion to the embodiment described in FIG. 12.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A self-supporting shower head system comprising:
a hollow center section configured to couple with a flexible tube;
at least one shower head coupled to the center section; and
at least one telescoping rod coupled to the center section, where the at least one telescoping rod is configured to extend away from and to retract toward the center section;
wherein the flexible tube is configured to couple with at least one shower outlet pipe and to provide water to the at least one shower head.

2. The shower head system of claim 1, wherein the at least one telescoping rod comprises two telescoping rods each extending from an end of the center section.

3. The shower head system of claim 1, wherein the at least one shower head comprises three shower heads, each coupled to the center section.

4. The shower head system of claim 1, wherein the at least one telescoping rod is configured to support, at least in part, the weight of the shower head system.

5. The shower head system of claim 1, wherein the at least one telescoping rod comprises a mechanism configured to exert a force on the at least one telescoping rod, where the force is directed away from the center section.

6. The shower head system of claim 5, wherein the mechanism includes a threaded rod.

7. The shower head system of claim 5, wherein the mechanism includes a spring.

8. The shower head system of claim 5, wherein the mechanism includes a wire release mechanism coupled to a pawl.

9. The shower head system of claim 8, wherein the pawl is configured to engage teeth fixed to the center section.

10. The shower head system of claim 9, wherein the at least one telescoping rod includes a button coupled to the wire release mechanism, where the button is configured to release the telescoping rod and to enable the telescoping rod to retract toward the center section.

11. The shower head system of claim 1, wherein an end of the at least one telescoping rod is configured to engage with a shower wall.

12. The shower head system of claim 11, wherein the at least one telescoping rod comprises a brake, where the brake is configured to support, at least in part, the weight of the shower head system.

13. The shower head system of claim 12, wherein the brake is configured to engage with a shower wall.

14. The shower head system of claim 13, wherein the brake is rotably fixed to the at least one telescoping rod.

15. The shower head system of claim 14, wherein the brake includes a cam lock configured to fix the position of the brake with respect to the at least one telescoping rod.

16. The shower head system of claim 14, wherein the brake is configured to extend at an angle from the at least one telescoping rod to the shower wall.

17. A method of installing a self-supporting shower head system in a shower stall, the self-supporting shower head system having a hollow center section configured to couple with a flexible tube, at least one shower head coupled to the center section, and at least one telescoping rod coupled to the center section, where the at least one telescoping rod is configured to extend away from and to retract toward the center section, where the flexible tube is configured to couple with at least one shower outlet pipe and to provide water to the at least one shower head, the method comprising:
extending the at least one telescoping rod to a wall of the shower stall; and
coupling the flexible tube to the at least one shower outlet pipe and to the center section.

18. The method of claim 17, further comprising:
using a threaded rod to maintain the extended position of the at least one telescoping rod.

19. The method of claim 17, further comprising:
using a spring to maintain the extended position of the at least one telescoping rod.

20. The method of claim 17, further comprising:
using a wire release mechanism coupled to a pawl to maintain the extended position of the at least one telescoping rod, where the pawl is configured to engage teeth fixed to the center section.

21. The method of claim 21, wherein the at least one telescoping rod includes a button coupled to the wire release mechanism, where the button is configured to release the telescoping rod and to enable the telescoping rod to retract toward the center section.

22. A self-supporting shower head system comprising:
a hollow center section configured to couple with a flexible tube;
at least one shower head coupled to the center section;
at least one telescoping rod coupled to the center section; and
means for extending and retracting the at least one telescoping rod;
wherein the flexible tube is configured to couple with at least one shower outlet pipe and to channel water to the at least one shower head.
